(19) United States
(12) Patent Application Publication
(10) Pub. No.: US 2015/0348655 A1
(43) Pub. Date: Dec. 3, 2015

(54) STABILITY COMPUTATION MONITORING DEVICE, REACTOR POWER STABILITY MONITORING SYSTEM AND REACTOR POWER STABILITY MONITORING METHOD

(71) Applicant: Kabushiki Kaisha Toshiba, Minato-ku (JP)

(72) Inventors: Shigehiro KONO, Tama (JP); Makoto TOMITAKA, Saitama (JP)

(73) Assignee: Kabushiki Kaisha Toshiba, Minato-ku (JP)

(21) Appl. No.: 14/626,119

(22) Filed: Feb. 19, 2015

(30) Foreign Application Priority Data
May 27, 2014 (JP) 2014-109507

(51) Int. Cl. G21C 17/108

(52) U.S. Cl. CPC G21C 17/108

(57) ABSTRACT

According to one embodiment, a stability computation monitoring device monitors in real time reactor power oscillation based on signals from neutron detectors. The device has: a detection sampling section sampling signals from the plurality of neutron detectors to output a detection sampling signal for each neutron detector; a local power monitoring section converting the detection sampling signal into a neutron flux signal; a low-pass filter applying low-pass filtering to neutron flux signal; a down-sampling section performing down-sampling for the neutron flux signals that have passed through the low-pass filter at a period longer than the detection sampling period; a wavelet transformation section applying Discrete Wavelet transformation to the neutron flux signals that have been subjected to the down-sampling to compute a DWT wavelet coefficient of each level; and a monitoring section monitoring the wavelet coefficient computed by the wavelet transformation section.

### CROSS-REFERENCE TO RELATED APPLICATION

This application is based upon and claims the benefit of priority from Japanese Patent Application No. 2014-109507 filed on May 27, 2014, the entire content of which is incorporated herein by reference.

### FIELD

Embodiments of the present invention relate to a stability computation monitoring device, a reactor power stability monitoring system and a reactor power stability monitoring method.

### BACKGROUND

A conventional reactor power stability monitoring device for a boiling water reactor monitors an average value (average value of local reactor power levels) of outputs of neutron detectors installed so as to surround a part of a fuel assembly. As such a reactor power stability monitoring device, an OPRM (Oscillation Power Range Monitor) is known. Such an OPRM is disclosed in Japanese Patent No. 3,064,084, and Japanese Patent No. 2,838,002, the entire contents of which are incorporated herein by reference.

The stability of reactor power of the boiling water reactor is evaluated by two aspects: fluctuation of neutron flux in the entire fuel storage region of the reactor; and local oscillation of reactor power. Such an evaluation is disclosed in IAEA TECDOC-1474, IAEA, November 2005, the entire content of which is incorporated herein by reference.

Further, there is disclosed technology that monitors instability of reactor power by checking presence or absence of harmonic wave based on a power spectrum density obtained through Fourier transform of a reactor power signal. Such a technology is disclosed in Japanese Patent No. 2,838,002, and Japanese Patent No. 3,847,988, the entire contents of which are incorporated herein by reference.

Many studies have been conducted regarding the stability of the boiling water reactor and have revealed that the local oscillation of the reactor power is caused due to instability of thermohydraulic characteristics and that oscillation of the entire reactor is caused due to nuclear characteristics.

The instability of thermohydraulic characteristics is caused due to a difference between coolant density in a core lower portion and coolant density in a core upper portion. In order to detect the oscillation due to the instability of thermohydraulic characteristics, it is necessary to separately monitor outputs of lower and upper portions of the same fuel channel. Further, in a case where there locally exists an unstable region of the thermohydraulic characteristics, a higher order mode power distribution having a maximum amplitude point set at symmetry positions in the core is generated. The oscillation due to nuclear characteristics is considered to be caused when this power distribution continuously exists without attenuation.

The presence or absence of the higher order mode power distribution can be determined by creating a power distribution curve using output signals of the neutron detectors arranged on a plane including a core center and the locally unstable region. However, the locally unstable regions do not always exist at horizontally symmetrical positions with respect to the core center, and the plane may have an inclination with respect to a horizontal plane.

However, as pointed out in IAEA TECDOC-1474, IAEA, November 2005, the existing OPRM (Oscillation Power Range Monitor) monitors a vertically averaged reactor local power, so that oscillation of a reactor power distribution in an axial direction cannot be monitored. Further, since only a local spatially averaged power is monitored, it is difficult to accurately detect power oscillation of the entire reactor.

Further, it is difficult to estimate in advance the inclination of the plane that characterizes an unstable state of the nuclear characteristics. Thus, monitoring of a degree of instability of the reactor power due to the nuclear characteristics is difficult to achieve simply by monitoring the fluctuation of the reactor power in planes of the limited levels using existing LPRMs (Local Power Range Monitors) installed at four height levels (levels A, B, C, and D) in a core axis direction.

### BRIEF DESCRIPTION OF THE DRAWINGS

The features and advantages of the present invention will become apparent from the discussion hereinbelow of specific, illustrative embodiments thereof presented in conjunction with the accompanying drawings, wherein:

FIG. 1 is a block diagram illustrating a configuration of a reactor power stability monitoring system according to a first embodiment;

FIG. 2 is a flowchart illustrating a signal processing flow in a reactor output stability monitoring method according to the first embodiment;

FIG. 3 is an example of a time chart of the output signal after detection sampling of the neutron detector;

FIG. 4 is a graph illustrating an example of characteristics of the low-pass filter.

FIG. 5 is an example of a time chart of the output signal after the down-sampling;

FIG. 6 is a graph illustrating an example of a result of the Discrete Wavelet transformation (DWT);

FIG. 7 is a graph illustrating an example of a time series variation the wavelet coefficient of the second level as a result of the DWT;

FIG. 8 is a graph illustrating an example of a time series variation of the wavelet coefficient of the first level as a result of the DWT; and

FIG. 9 is a block diagram illustrating a configuration of the reactor power stability monitoring system according to a second embodiment.

### DETAILED DESCRIPTION

Embodiments of the present invention have been made to solve the above problems, and an object thereof is to monitor in real time the oscillation of the reactor power by using signals of neutron detectors of a conventional power range monitoring system.

According to an embodiment, there is provided a stability computation monitoring device that monitors in real time reactor power oscillation based on signals from a plurality of neutron detectors that measure neutrons in a reactor core, the device comprising: a detection sampling section that samples signals from the plurality of neutron detectors at a common detection sampling period to output a detection sampling signal for each neutron detector; a local power monitoring section that converts each of the detection sampling signals into a neutron flux signal; a low-pass filter that applies low-pass filtering to each of the neutron flux signals; a down-sampling section that performs down-sampling for each of the neutron flux signals that have passed through the low-pass filter at a period longer than the detection sampling period; a wavelet transformation section that applies Discrete Wavelet transformation (DWT) to the neutron flux signals that have been subjected to the down-sampling to compute a DWT wavelet coefficient of each level for each neutron flux signal; and a monitoring section that monitors the wavelet coefficient computed by the wavelet transformation section.

According to an embodiment, there is provided a reactor power stability monitoring system, comprising: a plurality of neutron detectors arranged in a reactor core; and a stability computation monitoring device that monitors stability of reactor power based on signals from the neutron detectors, the device including: a detection sampling section that samples signals from the plurality of neutron detectors at a common detection sampling period to output a detection sampling signal for each neutron detector; a local power monitoring section that converts each of the detection sampling signals into a neutron flux signal; a low-pass filter that applies low-pass filtering to each neutron flux signal; a down-sampling section that performs down-sampling for each of the neutron flux signals that have passed through the low-pass filter at a period longer than the detection sampling period; a wavelet transformation section that applies Discrete Wavelet transformation (DWT) to the neutron flux signals that have been subjected to the down-sampling to compute a DWT wavelet coefficient of each level for each neutron flux signal; and a monitoring section that monitors the wavelet coefficient computed by the wavelet transformation section.

According to an embodiment, there is provided a reactor power stability monitoring method of monitoring in real time reactor power oscillation based on signals from a plurality of neutron detectors that measure neutrons in a reactor core, the method comprising: a detection sampling step for sampling signals from the plurality of neutron detectors at a common detection sampling period to output a detection sampling signal for each neutron detector; a conversion step for converting the detection sampling signals into neutron flux signals; a low-pass filtering step for applying low-pass filtering to the neutron flux signals; a down-sampling step for performing down-sampling for the neutron flux signals that have passed through the low-pass filter at a period longer than the detection sampling period; a wavelet transformation step for applying DWT to the neutron flux signals that have been subjected to the down-sampling to compute a DWT wavelet coefficient of each level for each neutron flux signal; and a monitoring step for monitoring the wavelet coefficient computed by the wavelet transformation step.

Now, embodiments of a stability computation monitoring device, a reactor power stability monitoring system and a reactor power stability monitoring method according to embodiments of the present invention will be described by referring to the accompanying drawings. Throughout the drawings, the same or similar components are denoted by the same reference symbols and will not be described repeatedly.

### First Embodiment

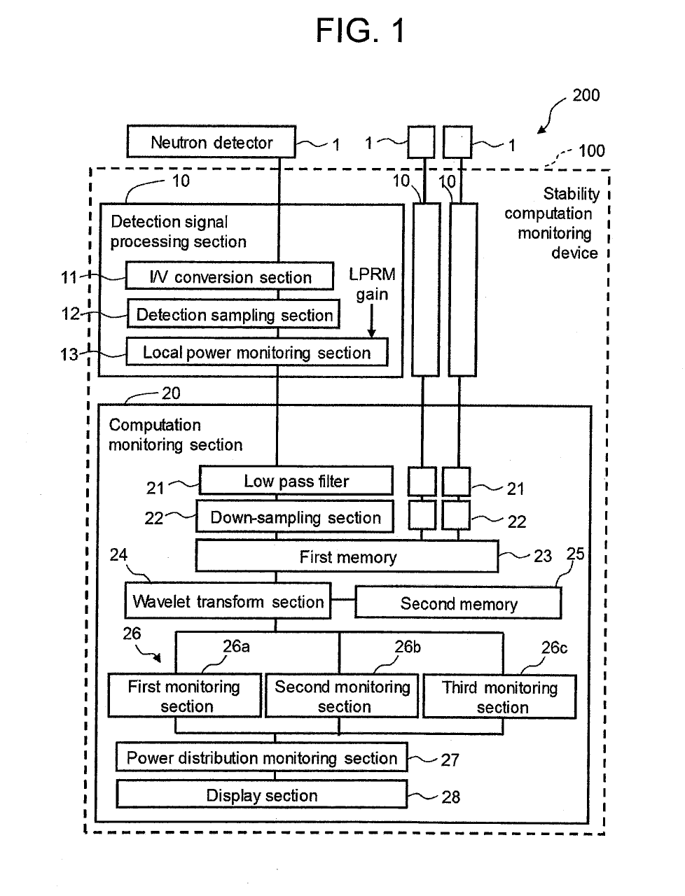

FIG. 1 is a block diagram illustrating a configuration of a reactor power stability monitoring system according to the first embodiment. A reactor power stability monitoring system 200 includes a plurality of neutron detectors 1 and a stability computation monitoring device 100. The neutron detector 1 is a detector for an LPRM (Local Power Range Monitor) to be inserted into a not-illustrated core. The neutron detector 1 is normally applied with a direct current of 100 V and generates a current signal proportional to a density of an irradiating neutron flux.

The stability computation monitoring device 100 includes a plurality of detection signal processing sections 10 and a computation monitoring section 20. As described later, a low-pass filter 21 and a down-sampling section 22 of the computation monitoring section 20, and the detection signal processing section 10 are provided so as to correspond to each of the plurality of neutron detectors 1.

For descriptive convenience, it is assumed and illustrated that three neutron detectors 1 are provided, although the number of the neutron detectors 1 typically corresponds to the total number (e.g., about 100, for each reactor) of LPRMs. The LPRMs may be divided into groups as long as a function of monitoring local oscillation is not impaired. In this case, in place of an output signal of the individual neutron detector 1, an average value of the signals of the neutron detectors 1 belonging to each group may be used. Alternatively, output signals of the neutron detectors 1 selected from all of the LPRMs in a reactor may be used.

The detection signal processing section 10 includes an I/V conversion section 11, a detection sampling section 12, and a local power monitoring section 13.

The I/V conversion section 11 converts a current output signal of the neutron detector 1 into a voltage signal. The detection sampling section 12 samples the output signal of the neutron detector 1 that has been converted into the voltage signal in a common sampling time for the output signals of all the neutron detectors 1. In general, high responsiveness is required in monitoring of the signals of the neutron detector so as to achieve quick shut down of the reactor when the reactor power abnormally increases, so that high-speed (e.g., 1 millisecond) sampling is performed.

Sensitivity of the neutron detector 1 is changed by neutron irradiation, so that the local power monitoring section 13 multiplies an output of the I/V conversion section 11 by an LPRM gain to obtain a local reactor power density (J/cm²) signal corresponding to a neutron flux (nv). The signal of the neutron detector 1 that has been converted into the voltage signal is multiplied by the LPRM gain into the local reactor power (LPRM signal).

The computation monitoring section 20 includes low-pass filters 21, down-sampling sections 22, a first memory 23, a wavelet transformation section 24, a second memory 25, a by-level monitoring section 26, and a power distribution monitoring section 27. As illustrated in FIG. 1, the by-level monitoring section 26 includes a first monitoring section 26a, a second monitoring section 26b, and a third monitoring section 26c. The number of above-mentioned monitoring sections which the by-level monitoring section 26 includes corresponds to the number of levels of multi-resolution analysis by wavelet transformation. As described above, the number of the low-pass filters 21 and the number of the down-sampling sections 22 are the same as the number of the neutron detectors 1.

Each low-pass filter 21 attenuates and removes a signal having a frequency higher than a specific frequency to thereby leave a frequency region lower than the specific frequency. The frequency region to be removed by the low-pass filter 21 is determined based on the following two conditions.

A first condition is to remove a signal having a frequency component equal to or higher than a frequency (e.g., 10 Hz) sufficiently higher than a higher one (e.g., 1.26 Hz) of a normal oscillation frequency and an estimated instability oscillation frequency which is the range detected by the neutron detector 1. A second condition is to remove a signal having a frequency component equal to or higher than ½ of a frequency at the point of down-sampling to be described later, i.e., at the point of resampling. For example, assuming that a re-sampling frequency is set to 20 Hz, that is, a sampling period is set to 50 ms, a frequency region equal to or higher than 10 Hz is removed.

Each down-sampling section 22 re-samples the signals that have been subjected to filtering by the corresponding low-pass filter 21 at a frequency (e.g., 20 Hz) lower than a sampling frequency used in the local power monitoring section 13. The first memory 23 memorizes the signals of the neutron detector 1 that have been subjected to down-sampling by each down-sampling section 22, i.e., data of neutron detection signals.

The wavelet transformation section 24 reads out, in a time series manner, a certain number of neutron detection signals corresponding to each neutron detector 1 and applies an n-level Discrete Wavelet transformation (DWT) to the read out neutron detection signals to compute a wavelet coefficient of each level. The second memory 25 memorizes the wavelet coefficient of each level obtained through the DWT applied to each neutron detector 1.

The first monitoring section 26a, the second monitoring section 26b, and the third monitoring section 26c of the by-level monitoring section 26 read out, from the second memory 25, the wavelet coefficients of their corresponding neutron detectors 1 and monitor the read out wavelet coefficients. The power distribution monitoring section 27 inputs thereto monitoring results from the first monitoring section 26a, the second monitoring section 26b, and the third monitoring section 26c of the by-level monitoring section 26 and determines whether or not stability of the reactor local power is maintained.

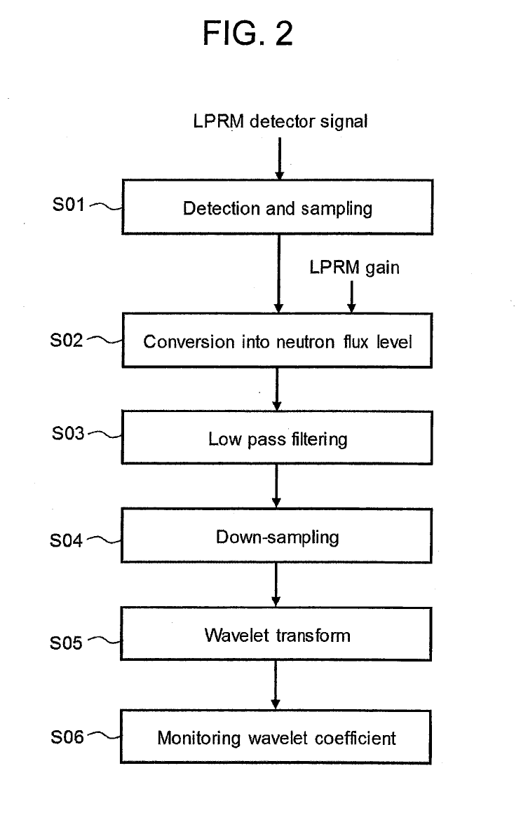

FIG. 2 is a flowchart illustrating a signal processing flow in a reactor output stability monitoring method according to the first embodiment. Here, a case where computation and processing of a signal from one neutron detector 1 is performed will be described. Processing of signals from a plurality of neutron detectors 1 will be described later.

First, the neutron detector 1 detects neutron, and the I/V conversion section 11 converts a current signal into a voltage signal, and the detection sampling section 12 performs sampling (step S01). Then, the local power monitoring section 13 multiplies the output of the I/V conversion section 11 that has been converted into the voltage signal by an LPRM gain to obtain a local reactor power density (J/cm²) signal corresponding to a neutron flux (nv) (step S02).

Then, the low-pass filter 21 applies low-pass filtering to the output signal (step S03). Subsequently, down-sampling is performed (step S04). For example, when a neutron flux signal after re-sampling is collected for about 51 seconds, the number of data becomes 1,025. The output signal of the neutron detector 1 includes, by about 2%, a fluctuation component with a 0.25 Hz frequency (one period=about 4 sec) which is generated when bubbles caused due to boiling of coolant pass near the detector. These data are stored in the first memory 23.

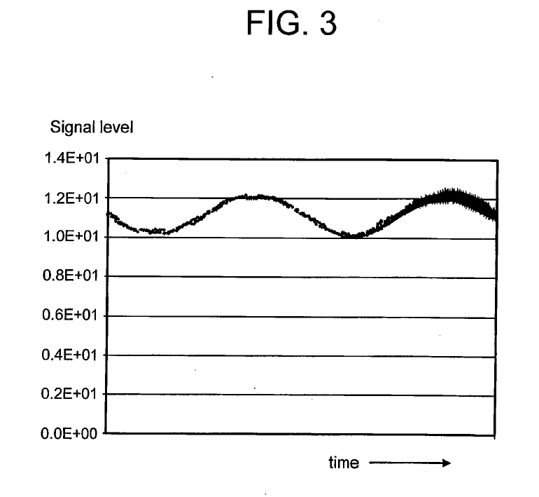

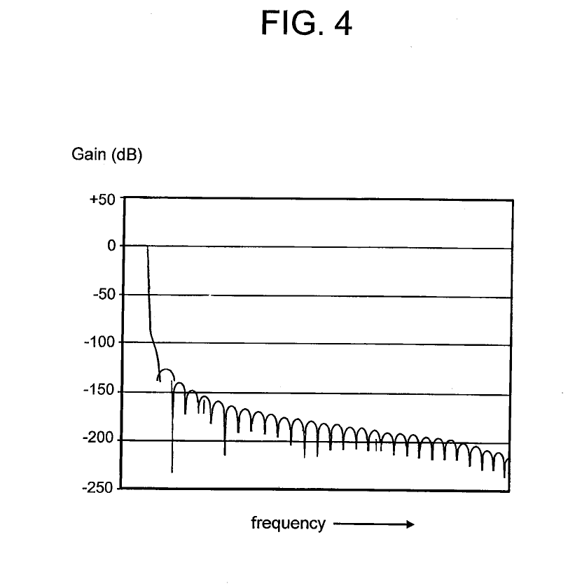

FIG. 3 is an example of a time chart of the output signal after detection sampling of the neutron detector. The number of sampling points shown in FIG. 3, i.e., the number of data is 51,200. FIG. 4 is a graph illustrating an example of characteristics of the low-pass filter. In a frequency range to be removed, an original gain is attenuated to about −50 dB to about −100 dB.

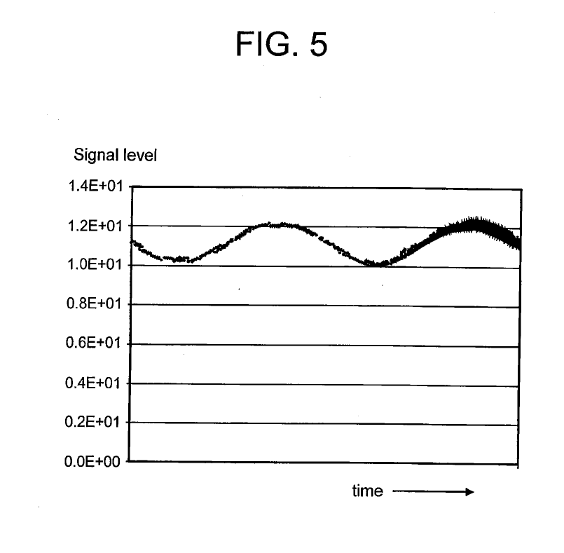

FIG. 5 is an example of a time chart of the output signal after the down-sampling. The number of sampling points shown in FIG. 5, i.e., the number of data is 1,024. A time series variation of the signal after the low-pass filtering and down-sampling does not significantly change as compared to a time series variation of the signal before the low-pass filtering and down-sampling. This reveals that there is no problem in the low-pass filtering processing and down-sampling processing.

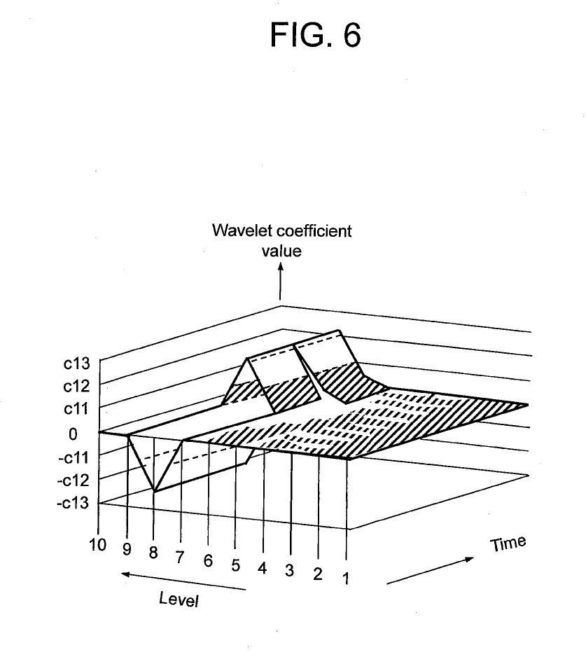

Subsequently, the DWT is performed using the data obtained through the down-sampling (step S05). For example, a case where the DWT is performed using 1,025 neutron flux signals after the re-sampling to obtain a one-minute time-frequency distribution diagram will be described as an example. FIG. 6 is a graph illustrating an example of a result of the DWT. In this three-dimensional graph, one of horizontal axes indicates levels obtained through the DWT, and the other one thereof indicates a time. A vertical axis, i.e., an axis extending perpendicular to a plane defined by the two axes, is a wavelet coefficient value of each level.

In the time-frequency distribution diagram, a correspondence relation between each level and frequency is as follows: a first level corresponds to 10 Hz, a second level corresponds to 5 Hz, a third level corresponds to 2.5 Hz, a fourth level corresponds to 1.26 Hz, a fifth level corresponds to 0.626 Hz, a sixth level corresponds to 0.313 Hz, a seventh level corresponds to 0.156 Hz, an eighth level corresponds to 0.078 Hz, a ninth level corresponds to 0.039 Hz, and a tenth level corresponds to 0.020 Hz. That is, a frequency fn of n-th level is represented by f1/2⁽ⁿ⁻¹⁾, where f1 is a frequency of the first level.

The DWT result reveals that the eighth level has a large peak value. The eighth level is a component corresponding to a fundamental frequency of the fluctuation of the neutron flux signal. In FIG. 6, a range where the wavelet coefficient has a value from 0 to c11 is hatched. However, in the hatched range, the wavelet coefficient value in an area other than the eighth level is smaller than that in the eighth level. Thus, when the first to tenth levels are displayed simultaneously, time series variation of the wavelet coefficient values of the levels other than the eighth level cannot be grasped.

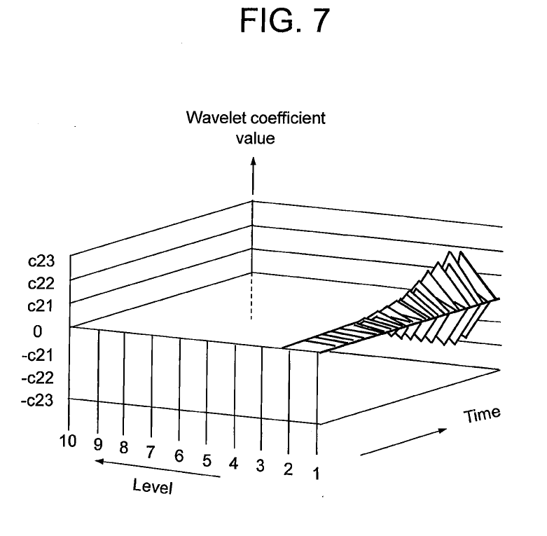

Then, monitoring of the wavelet coefficient is performed (step S06). FIG. 7 is a graph illustrating an example of a time series variation of the wavelet coefficient of the second level as a result of the DWT. In this graph, only the second level is extracted, and a scale of the vertical axis is changed. As a result, the wavelet coefficient of the second level temporally increases. That is, it is clear that a frequency component corresponding to 5 Hz increases.

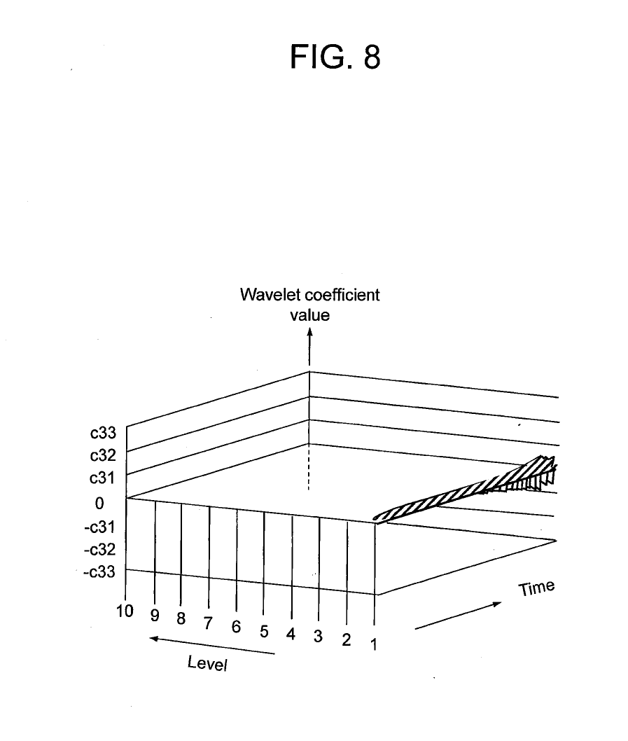

FIG. 8 is a graph illustrating an example of a time series variation of the wavelet coefficient of the first level as a result of the DWT. In this graph, only the first level is extracted, and a scale of the vertical axis is changed. As a result, the wavelet coefficient of the first level temporally increases. That is, it is clear that a frequency component corresponding to 10 Hz increases.

By monitoring the time series variation of the wavelet coefficient for each DWT level as described above, monitoring of the reactor power stability can be achieved. Specifically, when an absolute value of the wavelet coefficient of any level exceeds a predetermined threshold value, the power distribution monitoring section 27 determines that an abnormality, i.e., a local oscillation phenomenon of the reactor power has occurred.

Alternatively, when a time series variation rate of an absolute value of the wavelet coefficient exceeds a predetermined threshold value, or when both one of the absolute value of the wavelet coefficient and time series variation rate of an absolute value of the wavelet coefficient exceed the corresponding threshold value, the power distribution monitoring section 27 may determine that the abnormality has occurred. Further alternatively, in the monitoring of the signal of each level, when a primary mode oscillation appears in a certain level as illustrated in FIG. 7, followed by appearance of a secondary mode oscillation in the next level or a higher-order oscillation in a level corresponding to a high frequency, the power distribution monitoring section 27 may determine that the abnormality has occurred.

FIG. 2 and subsequent figures illustrate a case where the computation and processing of a signal from one neutron detector 1 are performed. On the other hand, in a case where the computation and processing of signals from a plurality of neutron detectors 1 are performed, the signals that have been subjected to the down-sampling by the respective down-sampling sections 22 are recorded in the first memory 23. Thus, processing from step S02 to step S04 are sequentially performed for the signals from the respective neutron detectors 1 and, after completion of one cycle, the processing flow proceeds to step S05. The reason this is enabled is that a symptom of an instability phenomenon usually lasts longer than one cycle interval.

The display section 28 displays, for each neutron flux signal, the thus obtained distribution diagram of the wavelet coefficient according to time and frequency. In order to optimize the number of display screens for monitoring, a plurality of neutron flux signals may be divided into groups so as to allow display to be performed for each group.

The reactor power stability monitoring system 200 monitors both a normal oscillation of the LPRM signal and unstable oscillation thereof. When the power distribution monitoring section 27 determines occurrence of the oscillation of the reactor power, for example, a selected control rod insertion signal is generated to suppress the reactor power.

As described above, according to the present embodiment, it is possible to monitor in real time the oscillation of the reactor power by using the signal of the neutron detector of a conventional power range monitoring system.

### Second Embodiment

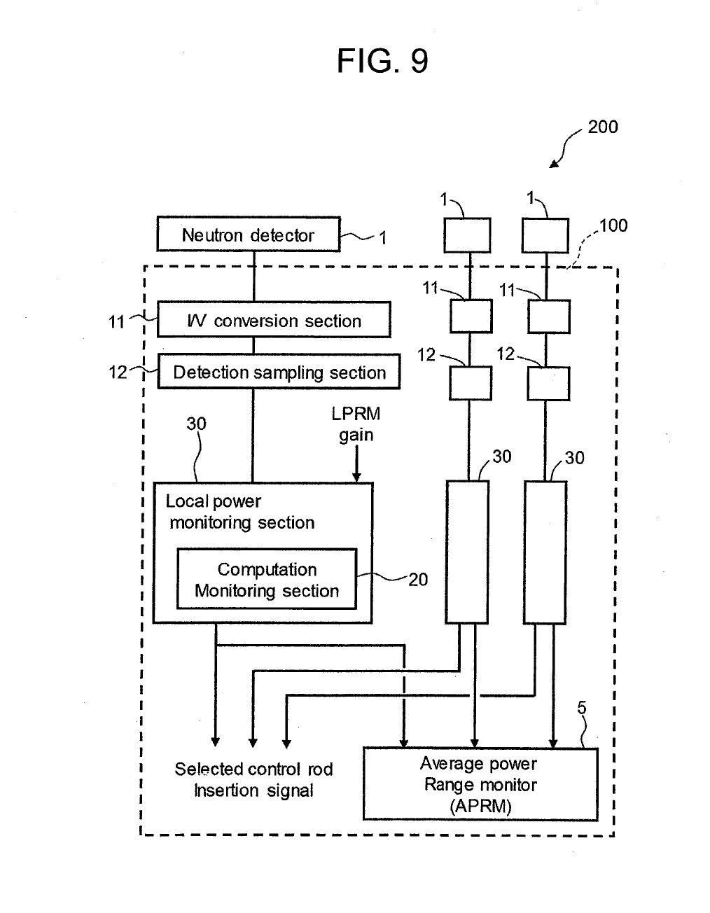

FIG. 9 is a block diagram illustrating a configuration of the reactor power stability monitoring system according to the second embodiment. The second embodiment is a modification of the above first embodiment.

The reactor power stability monitoring system 200 according to the present embodiment includes the neutron detectors 1 and local power monitoring sections 30. Each of the local power monitoring sections 30 has the computation monitoring section 20. That is, in the first embodiment, a part of the computation monitoring section 20 is provided so as to correspond to each neutron detector 1; on the other hand, in the second embodiment, the computation monitoring section 20 is provided into the local power monitoring section 30 so as to correspond to each neutron detector 1.

In each local power monitoring section 30, reactor power stability is determined by the computation monitoring section 20. A result of the determination is output from the local power monitoring section 30 to an average power range monitoring section (APRM) 5. When it is determined that an abnormality has occurred, a selected control rod insertion signal is output from the local power monitoring section 30 that has determined the occurrence of abnormality to a not illustrated reactor power control system.

According to the present embodiment, there is provided, as a part of the function of the local power monitoring section 30, the computation monitoring section 20 realized by an integrated circuit such as a programmable logic device and configured to perform the reactor power stability monitoring. Thus, a local oscillation state of the core can be monitored for each LPRM detector, and the selected control rod insertion signal can be generated for each LPRM detector.

Thus, providing the computation monitoring section 20 so as to correspond to each neutron detector 1 can reduce processing time, thereby allowing an instability phenomenon that may be unexpectedly generated to be grasped in an early stage.

Further, the reactor power stability determination can be performed in a multiplexed manner in each LPRM detector, thereby allowing a highly reliable reactor power stability monitoring device to be provided.

### Other Embodiments

While the present invention is described above by way of several embodiments, the above described embodiments, are presented only as examples without any intention of limiting the scope of the present invention.

Any of the characteristic features of two or more than two of the above described embodiments may be combined for use.

Furthermore, the above described embodiments may be modified in various different ways. For example, any of the components of the embodiments may be omitted, replaced or altered without departing from the spirit and scope of the invention.

All those embodiments and their modifications are within the spirit and scope of the present invention specifically defined in the appended claims and their equivalents.

What is claimed is:

1. A stability computation monitoring device that monitors in real time reactor power oscillation based on signals from a plurality of neutron detectors that measure neutrons in a reactor core, the device comprising:
a detection sampling section that samples signals from the plurality of neutron detectors at a common detection sampling period to output a detection sampling signal for each neutron detector;
a local power monitoring section that converts each of the detection sampling signals into a neutron flux signal;
a low-pass filter that applies low-pass filtering to each of the neutron flux signals;
a down-sampling section that performs down-sampling for each of the neutron flux signals that have passed through the low-pass filter at a period longer than the detection sampling period;
a wavelet transformation section that applies Discrete Wavelet transformation (DWT) to the neutron flux signals that have been subjected to the down-sampling to compute a DWT wavelet coefficient of each level for each neutron flux signal; and
a monitoring section that monitors the wavelet coefficient computed by the wavelet transformation section.

2. The stability computation monitoring device according to claim 1, wherein
the local power monitoring section is configured to perform the conversion for an average value of the signals from the neutron detector group obtained by dividing the plurality of the neutron detectors into a plurality of groups.

3. The stability computation monitoring device according to claim 1, wherein
the monitoring section is configured to compute a moving time average value of the wavelet coefficient of each level, to compare the wavelet coefficient computed for each level with the moving time average value, to calculate a difference between them, and to determine occurrence of an abnormality when an absolute value of the difference exceeds a reference value.

4. The stability computation monitoring device according to claim 1, further comprising a display section that displays a distribution diagram of the wavelet coefficient according to a time and a frequency for each of the neutron flux signals from the plurality of neutron detectors.

5. The stability computation monitoring device according to claim 2, further comprising a display section that displays a distribution diagram of the wavelet coefficient according to a time and a frequency for each of the neutron flux signals from the plurality of neutron detectors.

6. The stability computation monitoring device according to claim 3, further comprising a display section that displays a distribution diagram of the wavelet coefficient according to a time and a frequency for each of the neutron flux signals from the plurality of neutron detectors.

7. A reactor power stability monitoring system, comprising:
a plurality of neutron detectors arranged in a reactor core; and
a stability computation monitoring device that monitors stability of reactor power based on signals from the neutron detectors, the device including:
a detection sampling section that samples signals from the plurality of neutron detectors at a common detection sampling period to output a detection sampling signal for each neutron detector;
a local power monitoring section that converts each of the detection sampling signals into a neutron flux signal;
a low-pass filter that applies low-pass filtering to each neutron flux signal;
a down-sampling section that performs down-sampling for each of the neutron flux signals that have passed through the low-pass filter at a period longer than the detection sampling period;
a wavelet transformation section that applies Discrete Wavelet transformation (DWT) to the neutron flux signals that have been subjected to the down-sampling to compute a DWT wavelet coefficient of each level for each neutron flux signal; and
a monitoring section that monitors the wavelet coefficient computed by the wavelet transformation section.

8. A reactor power stability monitoring method of monitoring in real time reactor power oscillation based on signals from a plurality of neutron detectors that measure neutrons in a reactor core, the method comprising:
a detection sampling step for sampling signals from the plurality of neutron detectors at a common detection sampling period to output a detection sampling signal for each neutron detector;
a conversion step for converting the detection sampling signals into neutron flux signals;
a low-pass filtering step for applying low-pass filtering to the neutron flux signals;
a down-sampling step for performing down-sampling for the neutron flux signals that have passed through the low-pass filter at a period longer than the detection sampling period;
a wavelet transformation step for applying DWT to the neutron flux signals that have been subjected to the down-sampling to compute a DWT wavelet coefficient of each level for each neutron flux signal; and
a monitoring step for monitoring the wavelet coefficient computed by the wavelet transformation step.
